(19) United States
(12) Patent Application Publication
(10) Pub. No.: US 2017/0100902 A1
(43) Pub. Date: Apr. 13, 2017

(54) NANOCOMPOSITE MICROCAPSULES FOR SELF-HEALING OF COMPOSITE ARTICLES

(71) Applicant: Wichita State University, Wichita, KS (US)

(72) Inventors: Ramazan Asmatulu, Wichita, KS (US); Vamsidhar Reddy Patlolla, Wichita, KS (US)

(21) Appl. No.: 15/309,038

(22) PCT Filed: Apr. 30, 2015
(86) PCT No.: PCT/US15/28601

§ 371 Date: Nov. 4, 2016

Related U.S. Application Data
(60) Provisional application No. 61/989,894, filed on May 7, 2014.

(51) Int. Cl. B29C 73/22; C08L 63/00; B29B 11/16; C08G 59/18; B29C 73/10; B29B 11/06; B01J 13/18; C08G 59/40

(52) U.S. Cl. CPC B29C 73/22; B01J 13/18; C08L 63/00; C08G 59/4007; C08G 59/188; B29C 73/10; B29B 11/06; B29B 11/16; B82Y 40/00

(57) ABSTRACT

Nanocomposite microcapsules for self-healing of composites. The nanocomposite microcapsules comprise a urea-formaldehyde shell encompassing a liquid core of polymerizable healing agent. The microcapsules further comprise nanoparticulates encompassed in the core and also present on the outer surface of the microcapsule shell. Self-healing composites with the nanocomposite microcapsules embedded in the composite polymer matrix are also described. Methods of making and using the same are also disclosed.

### CROSS-REFERENCE TO RELATED APPLICATIONS

The present application claims the priority benefit of U.S. Provisional Patent Application Ser. No. 61/989,894, filed May 7, 2014 entitled NANOCOMPOSITE SPHERES FOR SELF-HEALING OF COMPOSITE ARTICLES, incorporated by reference in its entirety herein.

### BACKGROUND OF THE INVENTION

Field of the Invention

The present invention relates to self-healing composites and processes and compositions for the manufacture thereof.

Description of Related Art

Composite materials, such as wind turbines, aircraft parts, etc. are prone to failure due to damage, which can be induced by lightning strikes, hail, runway debris, tool drops, vehicle collision, bird strikes, vibration, friction, heat build-up, and weather, etc. The aforementioned factors cause localized damage in the composite laminate, compromising the structural integrity, in the form of matrix cracking, fiber fracture, debonding, delamination, fiber pullout, micro-buckling, kind bands, cone fracture, and the like. Composite wind turbine blades are extensively subjected to cyclic loadings, which in turn cause micro and nanoscale cracks, and thus lead to fatigue and failure in a shorter service time. To ensure safe operations and prevent catastrophic failures, composite laminates designed for primary aircraft structures need to meet impact damage tolerance and durability requirements.

To prevent catastrophic failure and increase the service life of composites, self-healing technology has been implemented in these fields. The technology can also be used to increase the composite's repair efficiency.

### SUMMARY

Described herein are nanocomposite microcapsules for self-healing of composites. The microcapsules generally comprise a urea-formaldehyde shell having an outer surface, and a liquid core comprising a polymerizable healing agent (e.g., dicyclopentadiene), which is encompassed by the urea-formaldehyde shell. The microcapsules also comprise nanoparticulates, wherein at least a portion of the nanoparticulates are dispersed in the liquid core, and wherein at least a portion of the outer surface of the microcapsule shell is covered by the nanoparticulates.

Self-healing composite articles are also described herein. The composite articles comprise generally a polymer matrix, fiber reinforcement, and a plurality of nanocomposite microcapsules according to the various embodiments of the invention embedded in the polymer matrix (preferably substantially uniformly throughout the polymer matrix).

Also described herein are methods of repairing a damaged region of a composite structure. The methods generally comprise providing a self-healing composite repair patch, moulding or machining the composite repair patch to fit the damaged region, and bonding the composite repair patch to the damaged region. The self-healing composite repair patch comprises a polymer matrix, fiber reinforcement, and a plurality of nanocomposite microcapsules according to the various embodiments of the invention embedded therein.

Methods of making a self-healing composite are also described herein. The methods generally comprise dispersing nanocomposite microcapsules according to the various embodiments of the invention in a prepolymer resin. The prepolymer resin is then combined with a fiber reinforcement using suitable known techniques, and the prepolymer resin is cured to yield a self-healing composite comprising a polymer matrix (e.g., the cured prepolymer resin) having the nanocomposite microcapsules embedded therein.

### BRIEF DESCRIPTION OF THE DRAWINGS

FIG. 1 shows (A) microspheres encapsulated with dicyclopentadiene without graphene nanoflakes; and (B) microspheres encapsulated with dicyclopentadiene with graphene nanoflakes;

FIG. 2 shows a scanning electron microscope (SEM) image of a dicyclopentadiene microcapsule with graphene nanoflakes;

FIG. 3 shows an SEM image of ruptured microcapsules;

FIG. 4 shows an SEM image of the urea-formaldehyde shell, and measurement of the shell wall thickness;

FIG. 5 is an SEM image of the inner surface of the urea-formaldehyde microcapsule;

FIG. 6 is an SEM image of dicyclopentadiene flowing out of the microcapsules after rupture;

FIG. 7 shows (A) a microscope image of ruptured microcapsules; and (B) a magnified image of ruptured microcapsules incorporating graphene nanoflakes;

FIG. 8 shows SEM images of (A) a microsphere encapsulated with dicyclopentadiene with graphene nanoflakes; and (B) ruptured microcapsules where the nanoflakes are visible dispersing from the microcapsule with the dicyclopentadiene;

FIG. 9 is an SEM image of the inner surface of the ruptured microcapsules;

FIG. 10 is an image of a microcapsule (A) before and (B) after lasering a hole in the capsule shell wall;

FIG. 11 is a top-down view of a microcapsule embedded in an epoxy resin;

FIG. 12 is a graph of the tensile test results comparing the tensile strength of untreated laminated epoxy composite to an epoxy composite including regular dicyclopentadiene microcapsules, and microcapsules containing graphene; and

FIG. 13 are SEM images of graphene nanoflakes in a composite crack at (A) 1200× and (B) 2500× magnification.

### DETAILED DESCRIPTION OF PREFERRED EMBODIMENTS

The present invention is broadly concerned with self-healing composites. These systems are inspired by biological systems where damage triggers a healing response (wound healing, but at slower rates). Thus, the term “self-healing,” as used herein refers to the fact that the repair process for the damaged portion of the composite is triggered and occurs automatically without outside intervention (e.g., human or machine) due to the presence of the self-healing nanocomposite microcapsules embedded in the composite. The concept of self-healing technology can be introduced into the composite article manufacturing to increase the lifetime of the composite article without any human involvement. The present invention provides an effective methodology to prevent crack formation and propagation in the composite blades using nanoscale inclusions (e.g., graphene and carbon nanotubes (“CNTs”)) and self-healing technology.

Nanocomposite microcapsules for use in the invention comprise a urea-formaldehyde shell surrounding/encapsulating a core, and preferably a liquid core. The core material is distinct from the shell and comprises a polymerizable healing agent and at least one nanoparticulate material dispersed therein. The polymerizable healing agent is typically a monomer and/or oligomer capable of rapidly polymerizing and/or curing upon release from a ruptured microcapsule as part of the automatic healing process. A particularly preferred healing agent is dicyclopentadiene (DCPD).

In addition to being encapsulated in the core by the shell, the nanoparticulates are also present on the exterior or outer surface of the capsule shell. Graphene nanoflakes are preferred nanoparticulates for use in the invention. Other nanoparticulates that can be used in lieu of or in combination with graphene include, single and multiwall carbon nanotubes, carbon fibers/nanofibers, carbon black, nanoclay, nanotalc, and/or boron nitride nanotubes and nanoflakes, and combinations thereof. These nanomaterials can be used in functionalized and non-functionalized forms to enhance the healing process and overall strength of the composites. For example, the nanoparticulates can be functionalized with amine, silane, and/or carboxyl groups. These nanoparticles block crack propagation and slow crack formation. These nanoscale inclusions also help restore strength to the composite when co-cured with the healing agent. The microcapsules will comprise from about 0.5 to about 4% by weight of the nanoparticulates, based upon the total amount of dicyclopentadiene in the microcapsules taken as 100% by weight.

The microcapsules have an average (mean) maximum surface-to-surface dimension of from about 10 pm to about 200 μm, and preferably from about 20 μm to about 100 μm. In the case of relatively spherical microcapsules, the maximum surface-to-surface dimension is the diameter. The shell wall has an average (mean) thickness of from about 200 nm to about 400 nm.

In one or more embodiments, the urea-formaldehyde microcapsules filled with dicyclopentadiene and with nanoparticulates in the core and on the capsule shell are embedded into a composite matrix to yield a self-healing composite material. The composite material generally comprises a polymer matrix (prepolymer), matrix curing agent, and fiber reinforcement distributed therein. The fiber reinforcement can be woven or nonwoven fibers, multi-ply fibrous sheets, random strand, particulate fibers, and the like, such that the type of composites contemplated herein include particulate composites, short and/or long strand fiber composites, continuous fiber composites, and laminates. Various types of fibers can be used to reinforce the polymer matrix, including, without limitation, fiberglass, carbon, metal, ceramic, para-aramid synthetic fibers (e.g., polyparaphenylene terephthalamide, aka KEVLAR), and other polymeric fibers, and the like. Exemplary polymer matrices include prepolymers of epoxy, vinylester, or polyester, phenolics, polyimides, polyamides, polypropylene, polyether ether ketone (PEEK), other thermoplastic or thermoset polymers, and the like. Suitable composite curing agents will depend upon the particular prepolymer matrix system used, and are known in the art. For example, amines are typically used for epoxy matrix systems.

Self-healing can be achieved by introducing the self-healing microcapsules into the polymer matrix before curing the composite. The amount of microcapsules can vary, but will range from about 0.1% to about 30% by weight, and preferably from about 1% to about 10% by weight, and preferably about 2% by weight, based upon the total weight of the composite material (resin, curing agent, and fiber reinforcement) taken as 100% by weight. The self-healing composite is formed by dispersing the microcapsules in the prepolymer resin, preferably using high speed stirring and ultrasonication. A dicyclopentadiene catalyst (Grubbs' catalyst) can also be added into the prepolymer matrix for faster self-healing, although is not required. In one or more embodiments, a Grubbs' catalyst is preferably excluded from the composite. That is, the composite is preferably essentially free of a Grubbs' catalyst or any other catalyst for the polymerizable self-healing agent. As used herein, “essentially free” means that the catalyst is not intentionally added as part of the composition, although it will be appreciated that impurities or residual traces may nonetheless be present, and generally means less than about 0.01% by weight of the catalyst is present, based upon the total amount of dicyclopentadiene in the composite, taken as 100% by weight.

The prepolymer matrix is then combined with the fiber reinforcement (e.g., by dispersing the fiber reinforcement in the matrix, impregnating the fiber reinforcement with the prepolymer matrix, applying a coating over the fiber reinforcement, etc.), followed by curing the prepolymer matrix to yield the cured composite material. Various curing mechanisms can be used, including electrostatic, van der Waals, acid-base, ring-opening metathesis polymerization, and the like. In general, the composite material is a composite article, which has been shaped and/or molded using various known techniques. In general, the composite article is in the Ruin of a self-sustaining body. The resulting composite will comprise the cured polymer matrix and fiber reinforcement with the self-healing nanocomposite microcapsules embedded therein and preferably distributed substantially uniformly throughout the body of the composite article.

When the composite body is damaged in such a manner that a breakage (aka crack) occurs in a portion of the body, a self-healing process is automatically initiated. That is, as the crack farms and propagates through the body, the nanocomposite microcapsules in the crack region are likewise broken or ruptured. The healing agent (dicyclopentadiene) and nanoparticulates are both released into the leading edge of the crack. The healing agent, once released, quickly cures, to repair the crack and inhibit further crack propagation. Various curing mechanisms can be used. When present, the released dicyclopentadiene reacts with the Grubbs' catalyst in the matrix and instantly heals the cracks by ring opening metathesis polymerization (ROMP). Alternatively, polymerization of the healing agent can proceed without the Grubbs' catalyst. Polymerization can also occur via electrostatic interaction and/or van der Waals interaction between the composite matrix resin and dicyclopentadiene monomers. Advantageously, the nanoparticulates and ruptured microcapsules (with nanoparticulates on the outer surface) also present in the crack region are embedded in the cured healing agent and provide reinforcement to yield a nanocomposite repaired region of increased strength and durability as compared to an unreinforced repair. In addition, even before crack formation, incorporation of the self-healing nanocomposite microcapsules increases the tensile strength of the composite, in addition to providing self-healing properties during crack formation. Thus, also described herein are composite articles having increased tensile strength properties. In particular, composite articles comprising the nanocomposite microcapsules embedded therein, and being essentially free of Grubbs' catalyst have at least bout 30% increased tensile strength as compared with the same composite matrix without the nanocomposite microcapsules.

Advantageously, the nanocomposite microcapsules can be incorporated into originally manufactured composite parts, such as aircraft primary, secondary (e.g., flaps), or tertiary structures (eg. fairings), wind turbine blades, automobile parts, marine vessels (e.g., ship hulls), armored vehicles, and the like. Alternatively, the nanocomposite microcapsules can be included in a composite repair patch, such as a composite patch for scarf or stepped repair. In scarf repair, the damaged site is prepared for repair by rounding off any corners of the repair hole, tapering the edges of the hole itself, etc. In step repair, the damaged hole is stepped down according to each ply of the composite material. Regardless, the repair patch composite body is then machined or moulded to fit the repair hole, and the repair patch is bonded to the repair site. When cracks start to propagate in the repaired area due to high localized stresses, the healing agent (dicyclopentadiene) and nanoparticulates embedded in the repair patch are both released into the leading edge of the crack and cured, inhibiting further crack propagation. A technique of using a self-healing repair patch would further increase the lifetime of the repaired composite and reduce the maintenance costs.

Additional advantages of the various embodiments of the invention will be apparent to those skilled in the art upon review of the disclosure herein and the working examples below. It will be appreciated that the various embodiments described herein are not necessarily mutually exclusive unless otherwise indicated herein. For example, a feature described or depicted in one embodiment may also be included in other embodiments, but is not necessarily included. Thus, the present invention encompasses a variety of combinations and/or integrations of the specific embodiments described herein.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments of the invention. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

### EXAMPLES

The following examples set forth methods in accordance with the invention. It is to be understood, however, that these examples are provided by way of illustration and nothing therein should be taken as a limitation upon the overall scope of the invention.

### Introduction

This is a new and novel project that utilizes the high strength and flexible nanoscale inclusions into the composite structures to increase their lifespan. The hypothesis is that the nanoscale inclusions distributed into the crack zones are cured with the optional catalyst and healing agent together to restore the original strength of the composites. This will most likely enhance the lifetime of the composite and eliminate maintenance and other costs. Result of this interdisciplinary project integrate a basic understanding of the process with macro and micro scale experiments. Nanotechnology-based self-healing processes will increase the lifetime and weight capacity of composites for higher and longer efficiency. Effects of lightning strikes that cause serious problems for composites, and may be reduced since these lighter and functional nanoscale inclusions are highly conductive.

In this project, a self-healing process is developed by introducing nanotechnology into composite manufacturing to produce lighter and stronger composites. This technology allows repairs of defects in the composite structures without any human involvement at a lower cost. The first part of the project focuses on a comprehensive evaluation of composite fabrication and characterization methods and other existing techniques currently utilized in composite manufacturing. The second part of this project focuses on the development and evaluation of the self-healing nanocomposite microcapsules, which increase the mechanical strength, and lifetime of the composites. The research focuses on the fabrication of several nanostructure microcapsules associated with nanoscale inclusions, and test and evaluate their performances.

Task 1: Dispersion of Nanoscale Inclusions: Graphene and CNTs tend to aggregate due to the intermolecular interactions, such as electrostatic, hydrophobic, and van der Waals, which makes the dispersion process difficult in polymer matrices. Thus, the effective utilization of the inclusions in a resin system strongly depends on the ability to disperse them homogeneously throughout the matrix in order to achieve good interfacial bonding, which will enhance load transfer and electrical and thermal conductivity. For these reasons, surface energy and surface charge of the inclusions can be changed by the addition of chemicals (e.g., benzalkoniumchloride, dimethylformamide and ethanol). Additionally, the nanoparticulates can be functionalized using amine, silane, and/or carboxyl groups to increase the inclusion and resin interactions. Ultrasonic vibration, high shear mixing, and mechanical stirring can be used to disperse the modified inclusions in the matrix materials.

Task 2: Fabrication of Nanocomposite Microcapsules and Catalysts: urea-formaldehyde microcapsules contain dicyclopentadiene and nanoparticulates, where dicyclopentadiene acts as the healing agent in the cracks, while the nanoparticulates inclusions improve the mechanical and electrical properties of the composite. When these nanoparticulates are dispersed into the crack zones during self-healing, they should further increase the fracture toughness and prevent the crack re-growth. This phenomenon can be determined experimentally. In this research, the nanoscale inclusions (0-4 wt %) are dispersed into the urea-formaldehyde microcapsules (20 and 200 μm). The wall of the microcapsules should withstand the curing temperature and pressure of the composite laminates, and also should break when a crack propagates. The wall thickness will be between 200 and 400 nm.

In general, the urea-formaldehyde microcapsule fabrication will start with the addition of 5 g ethylene maleic anhydride (EMA) into 200 ml of deionized (DI) water at 1200 rpm agitation. Simultaneously, 5 g urea, 0.5 g ammonium chloride and 0.5 g resorcinol will be transferred to the previous solution. After the dissolution and pH adjustment with NaOH solution (pH from 2.6 to 3.5), 12.75 g formaldehyde, 59 g dicyclopentadiene and known amount of nanoparticulates will be sequentially added, and the solution will be stirred for 4 hours at 55° C. The variables can be changed based on the experimental conditions and outcomes. After washing with DI water and drying in air for two days, the urea-formaldehyde microcapsules associated with the nanoscale inclusions will be stored at 4° C. until used.

It is found that the Grubbs catalyst, when used, is not uniformly distributed in the composition matrix, such as an epoxy matrix, and the epoxy curing agent diethylenetriamine (DETA) also destroys the Grubbs catalyst. This phenomenon reduces the amount of catalyst available for the polymerization and self-healing performance. To address these problems, the catalyst is encapsulated in wax microspheres prior the further processing. This ensures the uniform distribution of the catalyst in the matrix, and protects the catalyst from DETA. The amount of catalyst in the self-healing system can be changed during the experiments. DI water, ethylene maleic anhydride and octanol (1 drop) will be placed in a beaker, stirred, and then submerged in the same water bath. This melts the wax and disperses the catalyst uniformly in the beaker. Then, the beaker is opened and the wax is poured into the aqueous solution. 2 minutes later, cold water (near 0° C.) is poured and the stirring is stopped to prevent the further reactions. The microcapsules are cooled in an ice bath and washed multiple times with a solvent to remove excess water. Finally, they are dried for about 30 minutes before mixing with the epoxy [8]. Using ultrasonication and high speed stirring, the microcapsules and catalysts can be dispersed uniformly into the epoxy prior to the vacuum assisted resin transfer molding (VARTM) process.

Task 3: Self-healable Composite Fabrication and Characterization: Vacuum Assisted Resin Transfer Molding (“VARTM”) is a composite manufacturing process in which the dry fibers are laid on the tool and vacuum sealed, and then the resin is drawn through with a vacuum pump. It is an ideal process to manufacture the large-scale composite structures for the wind and aircraft industries. In this project, the nanocomposite microcapsules associated with nanoscale inclusions are dispersed in the resin system. A thin layer (1-3 mm thick) of fibers are placed in a VARTM unit to prepare a number of samples using the resins incorporated with urea-formaldehyde microcapsules and hardener that are cured at different temperatures and pressures. After the curing process at ambient or elevated temperatures, the samples are cut into dog-bone shapes for mechanical testing.

Universal tensile testing, fatigue testing and three-point bending units can be employed to determine the mechanical properties of the self-healed samples, including young modulus, elongation, ductility, stiffness, and yield and ultimate tensile strengths. In this task, we also apply external forces on the self-healable composites to create crack propagation, and then determine the mechanical properties. The behavior of the crack re-growth is examined, as well. This research is aimed at restoring 85-95% of the virgin mechanical properties and to reduce the maintenance costs using nanotechnology and self-healing technology.

The present project will conduct experimental and theoretical studies on nanotechnology and self-healing technology. This research will likely enhance the fundamental understanding of the process, which, to date, is very limited in terms of mechanical strength improvement of the damaged composites. This novel process can also be used to address other closely related problems in aircraft, marine, wind, defense, and medical industries.

### Example 1

### Preparation of Nanoparticle-Induced Microcapsules

To manufacture the self-healing microcapsules, a beaker with 50 ml deionized water was placed on a hot plate. Then, 12.18 ml of 2.5 wt % aqueous solution of Ethylene Maleic Anhydride (EMA) was added to the beaker under high speed stirring between 800-1000 rpm. These stirring speeds have been chosen to accommodate the nanoparticles inside the microspheres. Simultaneously, 1.25g of urea, 0.125 g of ammonium chloride, and 0.125 g of resorcinol were added to this solution. The pH of the solution was raised from 3.12 to 3.50 by adding sodium hydroxide. A drop of 1 octanol was added to prevent surface bubbles. A slow stream of 14.75 g of dicyclopentadiene, which is the healing agent, was then added to this solution and was allowed to stabilize for 5 minutes. After adding dicyclopentadiene, 0.3 g of graphene nanoflakes (aka nanoparticles) was added to the solution. After stabilization, 3.1875 g of formaldehyde was added to the solution. The entire solution was then stirred continuously for 4 hours at a temperature of 450° C.

After 4 hours of agitation, urea-formaldehyde microcapsules were formed. The entire mixture was then allowed to cool to ambient temperature. The microcapsules were separated from the solution under vacuum and were washed 5 times with deionized water to remove excess solvent. The microcapsules were then allowed to air dry for 24 to 48 hours.

For our experiments the amount of nanoparticles used is 2 wt % of the dicyclopentadiene. Therefore for 14.75 g of dicyclopentadiene we used 0.3 g of nanoparticles and the microcapsules contained the mixture of both dicyclopentadiene and the nanoparticles.

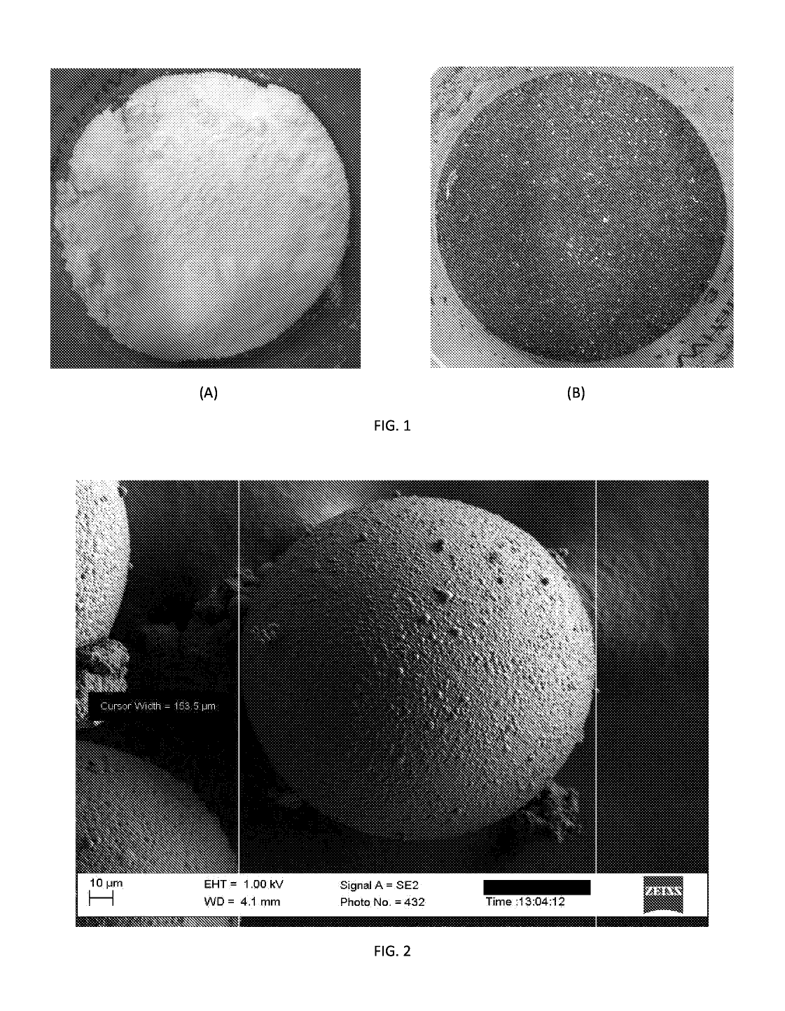

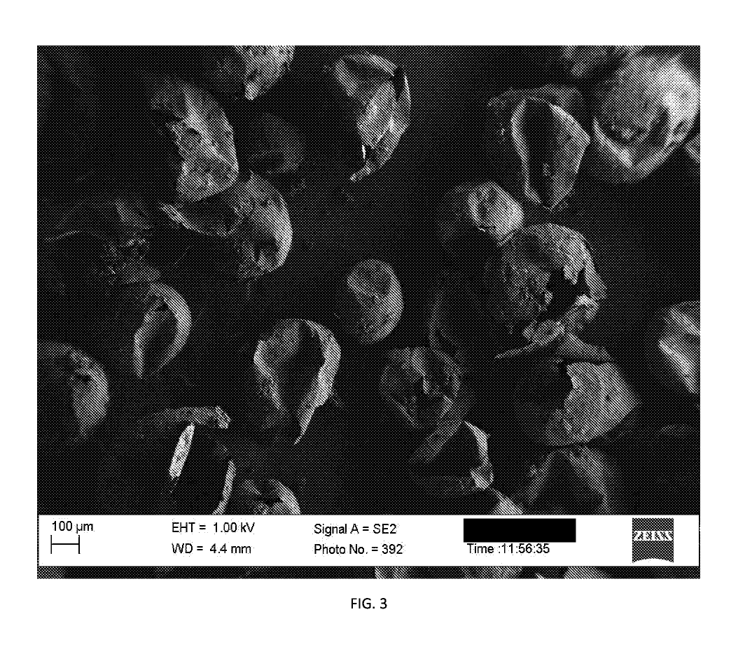

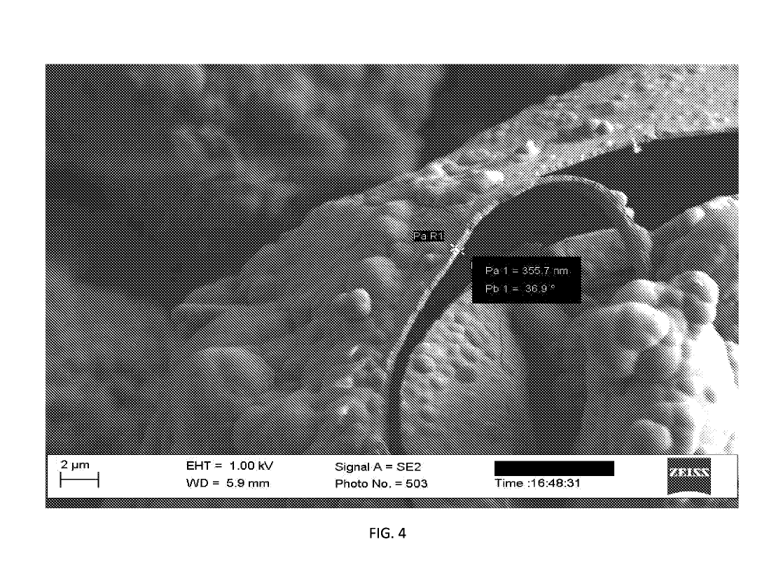

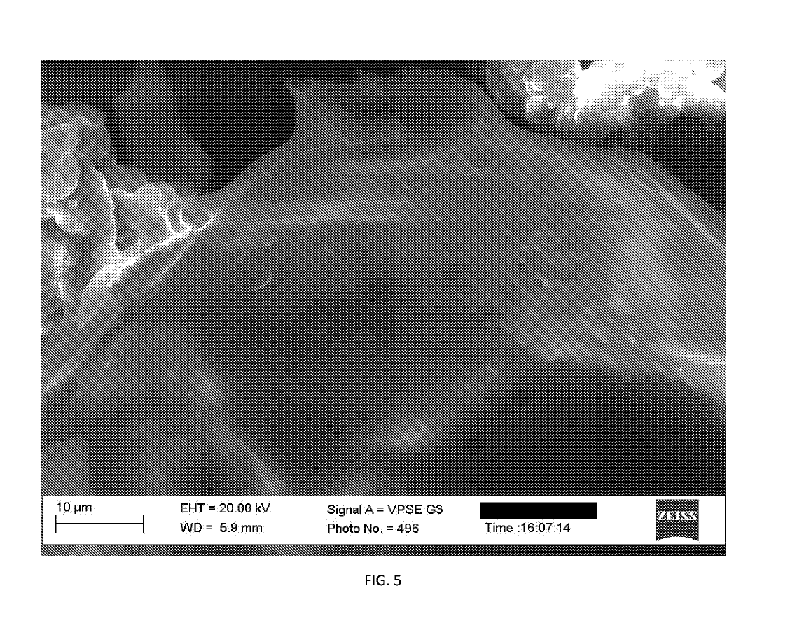

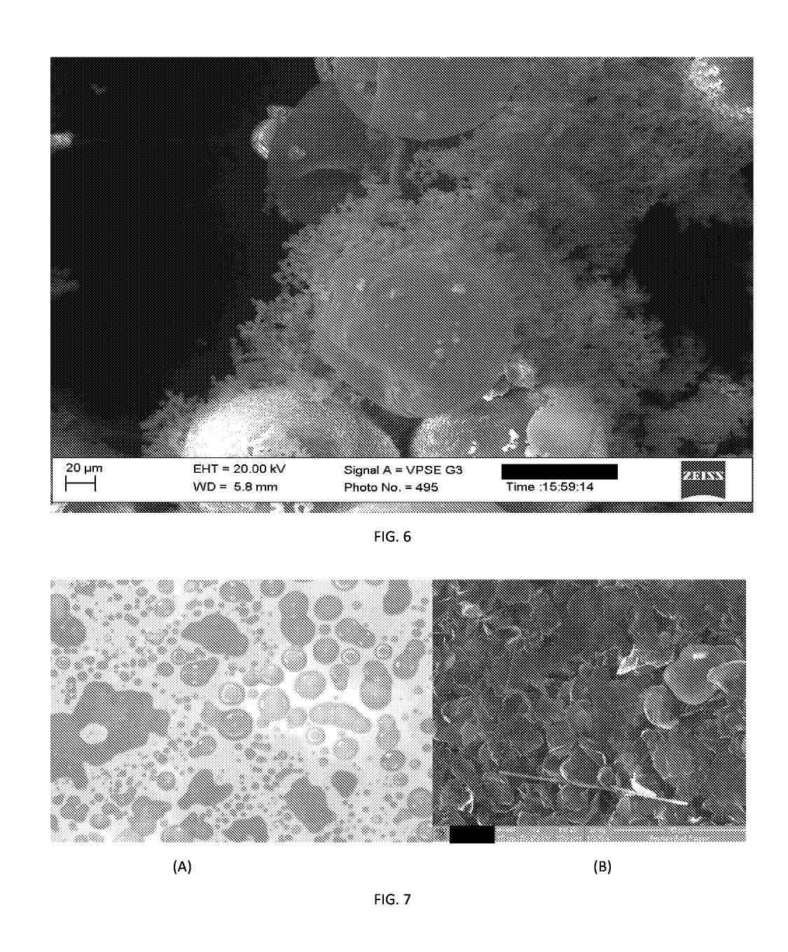

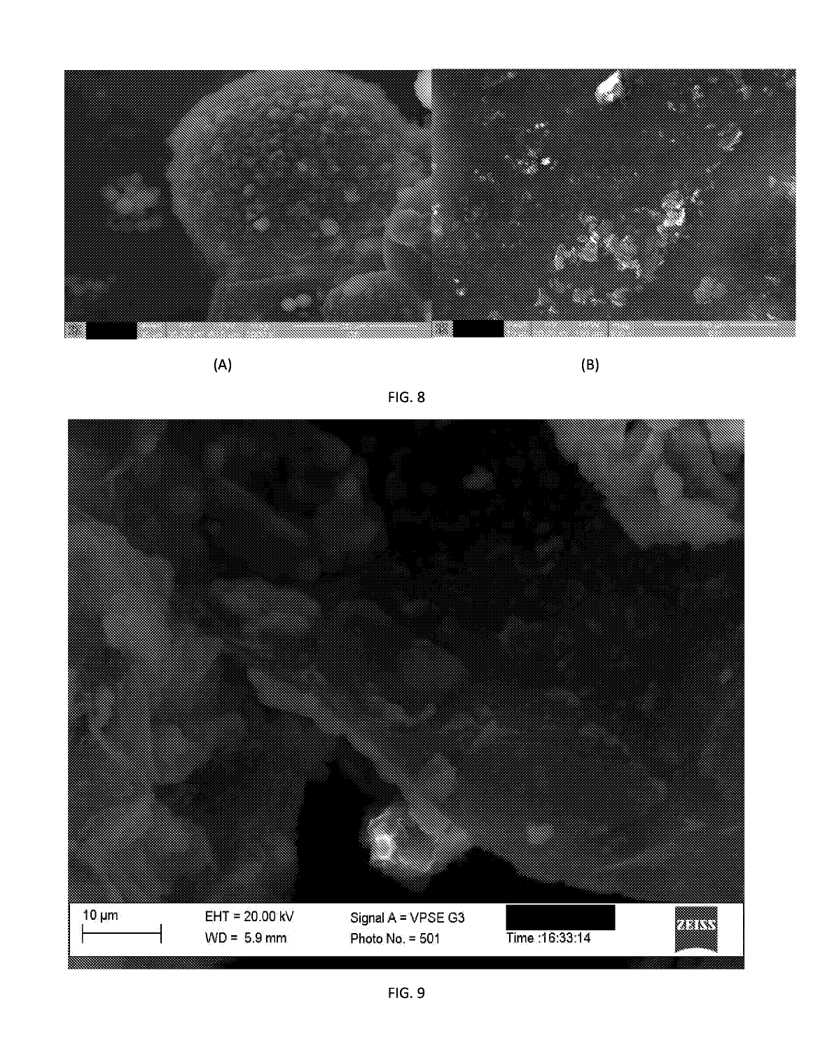

Images of the microcapsules are shown in FIGS. 1-9. FIG. 1 shows microcapsules formed without graphene nanoflakes and microcapsules formed with the graphene nanoflakes. FIG. 2 is an SEM image of a dicyclopentadiene microcapsule, containing graphene. FIG. 3 is an SEM image of ruptured microcapsules. FIGS. 4-5 show the capsule wall. FIG. 6 shows dicyclopentadiene flowing out of the microcapsules (dicyclopentadiene was initially liquid, then dries out). FIG. 7 shows a microscopic image of microcapsules after rupturing. FIG. 8 shows (A) the graphene microcapsules before being crushed and (B) after being crushed, with the healing agent (dicyclopentadiene) and the graphene being dispersed from the capsule. FIG. 9 is a further image of the inner surface of the microcapsules with the graphene nanoflakes.

EDS analysis was performed to determine the elemental differences between conventional dicyclopentadiene (DCPD) microcapsules and the graphene-induced microcapsules. To determine the chemical structure of the sample, x-rays are focused onto the samples individually. Since each element has a different atomic structure, the EDS gives a set of peaks on the x-ray spectrum (not shown). A summary of the results is provided in the table below.

Elemental distribution

| | DCPD-only | | DCPD/ | |
|---|---|---|---|---|
| | microcapsules | | Graphene microcapsules | |
| Element | Weight % | Atomic % | Weight % | Atomic % |
| C | 40.67 +/− 1.03 | 45.87 | 47.20 +/− 1.17 | 52.51 |
| N | 32.22 +/− 1.46 | 31.17 | 28.49 +/− 1.56 | 27.19 |
| O | 27.11 +/− 0.98 | 22.96 | 24.31 +/− 0.94 | 20.30 |
| Totals | 100.00 | 100.00 | 100.00 | 100.00 |

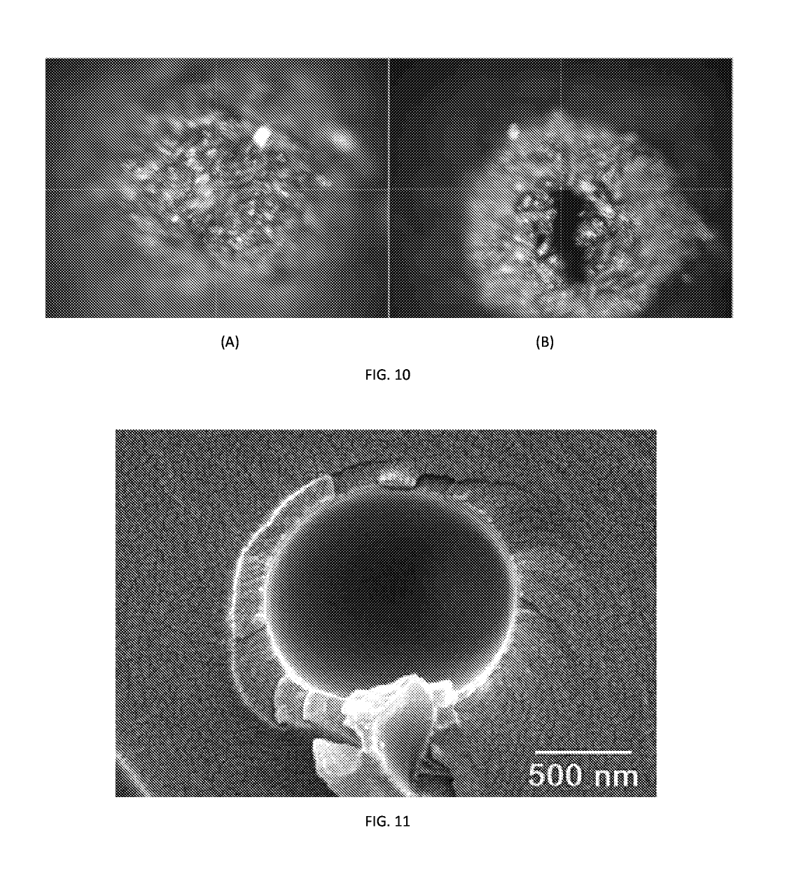

Raman spectroscopy has been used to determine the bonds present in the dicyclopentadiene and nanoparticle-induced (nanocomposite) dicyclopentadiene microcapsules. To determine if the nanoparticles are encapsulated, a hole was created on the top surface of the graphene encapsulated microcapsule. Specifically, a hole was created in the microcapsule using a laser to remove the urea-formaldehyde shell and a spectra was recorded. The dicyclopentadiene leaked out of the capsule once the hole was created. The spectra (not shown) also revealed the presence of graphene being encapsulated. As shown in FIG. 10, it was observed that the graphene was also present on the outer shell of the microcapsules. The data confirms that the nanoparticles are indeed encapsulated and are also present on the outer surface of the microcapsule which would add to the strength of the microcapsule.

Differential Scanning calorimetry (DSC) is used to determine the enthalpy of fusion and glass transition temperatures of polymers. It monitors the phase transitions of the sample and the chemical reactions associated with the heat effects as a function of temperature. It specifies the polymer melting point, decomposition and the temperatures at which the maximum reaction rate of the polymer occurs. The difference in the heat flow of the sample is measured with respect to a reference sample which usually an empty aluminum pan. The samples were placed on the holders beneath which are the resistance heaters and the temperature sensors. Thus the heat flow is calculated using the power difference between the two holders to maintain both the samples at same temperature. The data (not shown) demonstrates a rise in the enthalpy starting at 35° C. and reaching the maximum at 65° C., illustrating the melting of dicyclopentadiene. The change in enthalpy at 170° C. and reaching a peak at 218.56° C. indicated the boiling of dicyclopentadiene. This peak also merges with the melting peak of the urea-formaldehyde shell at around 260° C. We also observed a decrease in the enthalpy between the dicyclopentadiene and the graphene-containing microcapsules. This is because of the reduction in the polymer quantities resulting in decrease in polymerization.

### Example 2

### Manufacturing of Composite Panels

The microcapsules with graphene nanoparticles prepared in Example 1 above, were then mixed into an epoxy resin using ultrasonication and high speed stirring. The microcapsules with graphene nanoparticles were first cooled in an ice bath. A drying agent was added and the capsules were washed with a solvent to remove excess EMA surfactant. The solution was then centrifuged to separate the capsules, and then allowed to dry for 0-30 minutes. The microcapsules were then mixed into the epoxy matrix using high speed stirring and ultrasonication.

We have prepared composite panels using 2 wt %, 4 wt %, and 6 wt % of the nanoparticle-containing microcapsules in the epoxy resin. We have observed that the panel with 2 wt % of the nanoparticle-containing microcapsules increased the tensile strength by 31.51%. The panel with 4 wt % of nanoparticle-containing microcapsules in epoxy showed no improvement when compared to the baseline panel. The composite panel with 6 wt % in the epoxy resin showed a considerable decrease in the strength of the panel when compared to the baseline panel. All the composite panels have been manufactured using wet lay-up technique using glass fibers. After the wet layup, the laminate was bagged and cured under vacuum for 24 hours at 50 ° C. The tensile test coupons were machined from the cured laminates. Woven glass fiber has been used as the reinforcements and EPON 828 has been used as the resin. The resin and the fiber volume fraction was 50% each. A SEM image of a microcapsule incorporated into the matrix is shown in FIG. 11.

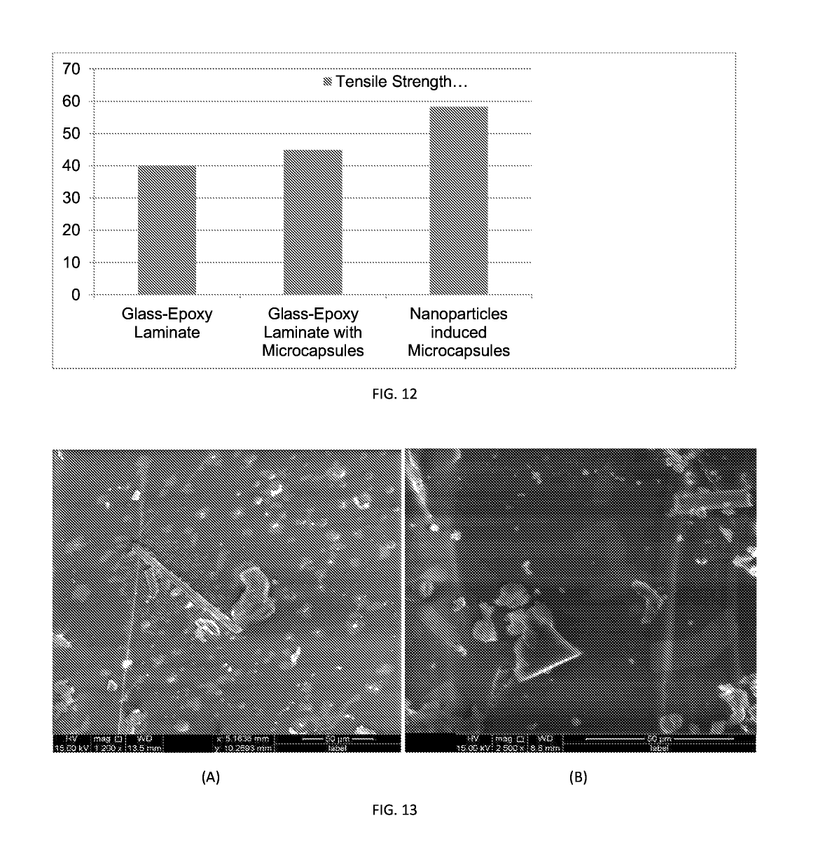

As shown in FIG. 12, we observed that the tensile strength increased by 31.51% upon inclusion of the graphene nanoparticles (and without including a Grubb's catalyst in the matrix). In all the three cases, the modulus remained constant. This instant curing of microcapsules incorporated with graphene nanoflakes can be an option for the impact damages of aircraft composites (e.g., bird strikes) and fatigue cracks during the services. As shown in FIG. 13, when the microcapsules are hit by a crack, they instantly stop the crack propagation.

We are currently investigating other materials which can be used for the creation of the microcapsules. Also we are using other types of nanoparticles to be encapsulated into the microcapsules.

### CONCLUSION

Our recent studies showed that the graphene nanoflakes were deposited on the outer surface of the microsphere shell, as well as inside the curing agent. This phenomenon would further increase the strength of the shell of the microcapsules. This would ensure that the shell does not break easily during the manufacturing process of the composite laminates. The deposition of nanoscale inclusions on the shell would enhance the surface morphology of the capsules. The encapsulation of the microcapsules was confirmed using Raman spectroscopy. Thus, when the capsules break inside the composite laminate, the nanomaterials flow into the crack front and would seal the crack further. The graphene nanoflakes into the microcapsules would also act load carriers to further enhance the overall strength of the laminate composites. This phenomenon would ensure that the life time of the composite can be enhanced without the requirement of Grubbs catalyst. Our approach makes the self-healing more affordable and easier for many composite manufacturers. Our tensile test results show an increase in tensile strength when graphene induced microcapsules are dispersed in a composite laminate without the Grubbs catalyst. A Grubbs catalysts can still be used in our system to accelerate the curing speed, but it is costly, makes the process more complex, when degraded it cannot be used, and may cause early curing if there is a leak from the capsules. The invention advantageously permits the avoidance of a Grubbs catalyst, and in fact demonstrates improved self-healing over systems using a catalyzed system.

1. A nanocomposite microcapsule for self-healing of composites, said microcapsule comprising:
a urea-formaldehyde shell having an outer surface;
a liquid core comprising a polymerizable healing agent, said urea-formaldehyde shell encompassing said liquid core; and
nanoparticulates, wherein at least a portion of said nanoparticulates are dispersed in said liquid core, and wherein at least a portion of said outer surface is covered by said nanoparticulates.

2. The nanocomposite microcapsule of claim 1, wherein said polymerizable healing agent is dicyclopentadiene.

3. The nanocomposite microcapsule of claim 1, wherein said nanoparticulates are selected from the group consisting of graphene nanoflakes, single and multiwall carbon nanotubes, carbon fibers/nanofibers, carbon black, nanoclay, nanotalc, boron nitride nanotubes, and boron nitride nanoflakes, and combinations thereof.

4. The nanocomposite microcapsule of claim 1, comprising from about 0.5 to about 4% by weight of said nanoparticulates, based upon the total amount of polymerizable healing agent in the microcapsule taken as 100% by weight.

5. The nanocomposite microcapsule of claim 1, having an average maximum surface-to-surface dimension of from about 10 μm to about 200 μm.

6. The nanocomposite microcapsule of claim 1, wherein said shell has an average thickness of from about 200 nm to about 400 nm.

7. A self-healing composite article comprising:
a polymer matrix;
fiber reinforcement; and
a plurality of nanocomposite microcapsules according to claim 1 embedded therein.

8. The self-healing composite article of claim 7, said composite being essentially free of Grubbs's catalyst.

9. The self-healing composite article of claim 8, said composite having increased tensile strength as compared to a composite article comprising said Grubbs' catalyst.

10. The self-healing composite article of claim 7, wherein said polymer matrix is selected from the group consisting of epoxies, vinylesters, polyesters, phenolics, polyimides, polyamides, polypropylenes, polyether ether ketones, and combinations thereof.

11. The self-healing composite article of claim 7, said article being in the form of a self-sustaining body, said nanocomposite microcapsules being substantially uniformly distributed throughout said body.

12. The self-healing composite article of claim 7, wherein said composite article has a tensile strength that is increased by at least about 30% as compared with the same composite matrix without said nanocomposite microcapsules.

13. The self-healing composite article of claim 7, wherein said article is an original manufactured composite part selected from the group consisting of aircraft primary, secondary, or tertiary structures, wind turbine blades, parts, marine vessels, and armored vehicles.

14. The self-healing composite article of claim 7, wherein said article is a composite repair patch.

15. A method of repairing a damaged region of a composite structure, said method comprising
providing a self-healing composite repair patch comprising: a polymer matrix, fiber reinforcement, and a plurality of nanocomposite microcapsules according to claim 1 embedded therein;
moulding or machining said composite repair patch to fit said damaged region; and
bonding said composite repair patch to said damaged region.

16. The method of claim 15, further comprising preparing said damaged region for repair prior to said moulding or machining

17. The method of claim 16, wherein said preparing comprises scarfing said damaged region to round any corners of said damaged region and taper any edges of said damaged region, wherein said composite repair patch is moulded or machined to fit said prepared damaged region.

18. A method of making a self-healing composite, said method comprising:
dispersing nanocomposite microcapsules according to claim 1 in a prepolymer resin;
combining said prepolymer resin after said dispersing with a fiber reinforcement; and
curing said prepolymer resin to yield a self-healing composite comprising a polymer matrix having said nanocomposite microcapsules embedded therein.

19. The method of claim 18, wherein said prepolymer resin is a prepolymer for a polymer system selected from the group consisting of epoxies, vinylesters, polyesters, phenolics, polyimides, polyamides, polypropylenes, polyether ether ketones, and combinations thereof.

20. The method of clam 18, wherein said fiber reinforcement is selected from the group consisting of woven or nonwoven fibers, multi-ply fibrous sheets, random strand, particulate fibers, and combinations thereof.

21. The method of claim 18, wherein said fiber reinforcement comprises fibers selected from the group consisting of fiberglass, metal, carbon, ceramic, polymeric fibers, and combinations thereof.

22. The method of claim 18, wherein said combining is selected from the group consisting of dispersing said fiber reinforcement in said prepolymer resin, impregnating said fiber reinforcement with said prepolymer resin, and applying a coating of said prepolymer resin over said fiber reinforcement.
